(19) United States
(12) Patent Application Publication
(10) Pub. No.: US 2009/0150499 A1
(43) Pub. Date: Jun. 11, 2009

(54) METHOD FOR SHARING INFORMATION OVER AN INSTANT MESSAGING NETWORK

(75) Inventors: Lucas W. Partridge, Southampton (GB); Timothy Ward, Southampton (GB)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/953,338

(22) Filed: Dec. 10, 2007

(51) Int. Cl. G06F 15/16

(52) U.S. Cl. 709/206

(57) ABSTRACT

A method for sharing information in applications via instant messaging (IM), the method includes: receiving a representation of an item in a first IM window on a sending device; recording metadata associated with the item with a sending plugin; sending the item and the associated recorded metadata to one or more receiving devices; receiving the item and the associated recorded metadata in a second IM window at the one or more receiving devices; opening the item with a receiving plugin; and wherein in response to the associated metadata the receiving plugin determines how to position and display information from the item; wherein the item is one or more of the following: a uniform resource locator (URL) and files generated with application software; and wherein the application software comprises word processors, spreadsheets, planning and scheduling, presentation, drawing, financial, statistical, and gaming.

### BACKGROUND OF THE INVENTION

1. Field of the Invention

This invention relates generally to communication via electronic devices, and more particularly to a method for sharing information over instant messaging networks.

2. Description of the Related Art

Instant messaging has become a central feature of modern life, and users have come to expect to receive electronic instant messages at any time and in virtually any place. For example, during the course of one day of travel, a user may receive instant messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day. The ease of use of instant messaging (IM) has led to the usage of IM for nearly any type of correspondence, file and application sharing and collaboration.

### SUMMARY OF THE INVENTION

Embodiments of the present invention include a method for sharing information in applications via instant messaging (IM), wherein the method includes: receiving a representation of an item in a first IM window on a sending device; recording metadata associated with the item with a sending plugin; sending the item and the associated recorded metadata to one or more receiving devices; receiving the item and the associated recorded metadata in a second IM window at the one or more receiving devices; opening the item with a receiving plugin; and wherein in response to the associated metadata the receiving plugin determines how to position and display information from the item; wherein the item is one or more of the following: a uniform resource locator (URL) and files generated with application software; and wherein the application software comprises word processors, spreadsheets, planning and scheduling, presentation, drawing, financial, statistical, and gaming.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and system for sharing information over instant messaging networks. Application sharing is accomplished with a file transfer mechanism and software plugins to coordinate document navigation and highlighting.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating a system level interaction between two computers with content being shared on application software during an IM session according to embodiments of the invention.

FIGS. 2A-2C illustrate a flow chart for a method for sharing information in applications via instant messaging according to embodiments of the invention.

FIGS. 3A and 3B illustrate a flow chart for a method for a receiving computer to select an application to process and display incoming information obtained in an IM session according to embodiments of the invention.

FIG. 4 illustrates a system for implementing embodiments of the invention.

The detailed description explains the preferred embodiments of the invention, together with advantages and features, by way of example with reference to the drawings.

### DETAILED DESCRIPTION

Existing instant messaging (IM) systems allow for the sharing of information between remote users over a network. The following three scenarios for sharing information are commonly found on IM systems with a first user (User1) and a second user (User2) engaged in an IM conversation, interaction, or session. In this patent the term ‘IM window’ refers to the IM application window that is used to display a conversation between two or more users.

In a first example scenario of an existing IM interaction, User1 is sharing an Internet web page with receiving user User2. User1 selects the uniform resource locator (URL) of the web page in their browser, and copies the URL to their clipboard. User1 subsequently pastes the URL into their IM window, and clicks on the send button to send the IM to User2. Upon receiving the IM, User2 double-clicks on the URL in their IM window to display the web page. A web browser is launched, if it is not already running, and sends a request to the URL to display the web page. However in this scenario, User1 has to separately describe to User2 which part of the web page User1 is looking at.

In a second example scenario of an existing IM interaction, User1 wants to share a portable document format (PDF) item with receiving User2. User1 finds the PDF in their file system, selects the file and drags the file onto their IM window with User2, and sends the IM to User2. Subsequently, User2 accepts the file transfer to save the file on User2's file system. User2 finds the PDF file on their file system, and double-clicks on the file to start application software to display the file. However, in this scenario User1 is required to tell User2 which page they are looking at for User2 to find the same page.

Similarly in a third example scenario, User1 wants to share a spreadsheet with User2, and would have to refer to which worksheet and cell they are looking at in order for User2 to look at that particular part of the spreadsheet.

In each of the previous existing example scenarios, the originating user (User1) is required to complete multiple steps. If the file has not been saved (scenario 3 for example), the originating user would have to save the file first (even if they didn't want to) before they could send the file in an IM. In addition, positional information related to the information content, such as how far down the web page, which page in a PDF, which cell in a spreadsheet, etc., must be transmitted independently and manually by the originating user. Finally, if the originating user wants to share information with a group of people, the originating user has to repeat the aforementioned steps for each person in the group. Embodiments of the disclosed invention both reduce the number of steps involved, and also eliminate the disadvantages outlined above.

Employing embodiments of the invention, the three previously described tasks may be carried out as follows. In each scenario, the application of User1 (the originating user) is assumed to have some form of icon, which may be dragged over the IM window that displays the current IM conversation between User1 and the intended recipient, User2. In the event User1 is not already engaged in a conversation with User2, User1 can choose to drag the icon over a name or icon that represents User2 in User1's IM system.

In the first scenario for sharing a web page that was outlined above, User1 drags the icon from their web browser onto their IM window, or an IM icon that represents the recipient (User2) in the event User1 is not already engaged in a conversation with User2. Subsequently, User2 is prompted by their IM browser whether they want to see User1's URL. In response to User2 acceptance (clicking OK), the URL is displayed in their web browser. In addition, with embodiments of the invention User2's displayed web page is automatically scrolled to the same point as the web page of User1

In the second scenario for sharing a PDF, with embodiments of the current invention, User1 drags an icon from the PDF generating application onto the IM window, or an IM icon that represents the recipient (User2) in the event User1 is not already engaged in a conversation with User2. Subsequently, User2 is prompted by their IM browser whether they want to see User1's PDF. In response to User2 acceptance, a PDF viewer application is launched (if not already running) and the PDF originating from User1 is displayed and advanced to the same page as User1 has open at the time of the IM was sent.

In a similar fashion in the third scenario, the transferred spreadsheet is made available to the recipient (User2) of the IM with the same worksheet and cells highlighted as the originating sender (User1) was viewing at the time of sending the IM. It is noted that if User1 has already saved the spreadsheet, and has subsequently modified the spreadsheet without resaving prior to the IM to User2, the spreadsheet is sent as a temporary copy to User2, and User1 is not required to resave the spreadsheet. The same principle applies to any editable documents that are sent by IM with embodiments of the invention.

Embodiments of the invention provide a method for dragging a representation of the currently open document or item onto an IM window. The representation may be a draggable icon or, for example, a set of tabs in a web browser if the user wants to send more then one URL. Embodiments of the invention provide a means for recording the current position of an open document, and for saving a temporary copy of an open editable document. In addition, embodiments of the invention provide a sending plugin for an IM system that is configured to store the positional information of a document, and transmits the positional information (metadata) along with the document in the IM, and a receiving plugin that interprets the positional information, launches the appropriate application and provides the application with the positional information. Once an open document has been transmitted by the sending user, if the sending user transmits the open document again (assuming no changes have occurred to the editable item), only the positional metadata is transferred to update the receiving user's view of the same item. It is noted that if a plugin has not been written for a particular application, the receiving portion of the IM system, in embodiments of the invention, in response to the sending IM opens the application associated with a recognized file extension and supplies the application with the transferred file or content.

In embodiments of the invention, in circumstances where the sending and receiving users use different applications to perform an activity, such as spreadsheet generation, or document generation, as long as the file formats are compatible, and both applications conform to the same IM plugin application programming interface (API), the receiving IM is able to exchange both the file and positional information contained in the sending IM. An API is a source code interface that an operating system or library (sub-programs) provides to support requests for services made of the operating system or library by computer programs.

The IM system, according to embodiments of the invention, provide a basket or trolley feature where the sending user may drag multiple items, possibly from different applications, into the same basket and have them all sent to a receiving user all at once. A receiving user may then decide which of the transmitted items or files they wish to receive, and the corresponding applications are opened on the receiving computing device in order to display the items or files.

In addition, embodiments of the invention are configured for a sending user to drag an item (or items) onto an IM icon representing a group of users, to have the item(s) sent to all the users in the group. The sending user does not have to already be in an IM conversation with each of the users in the group (list of IM users).

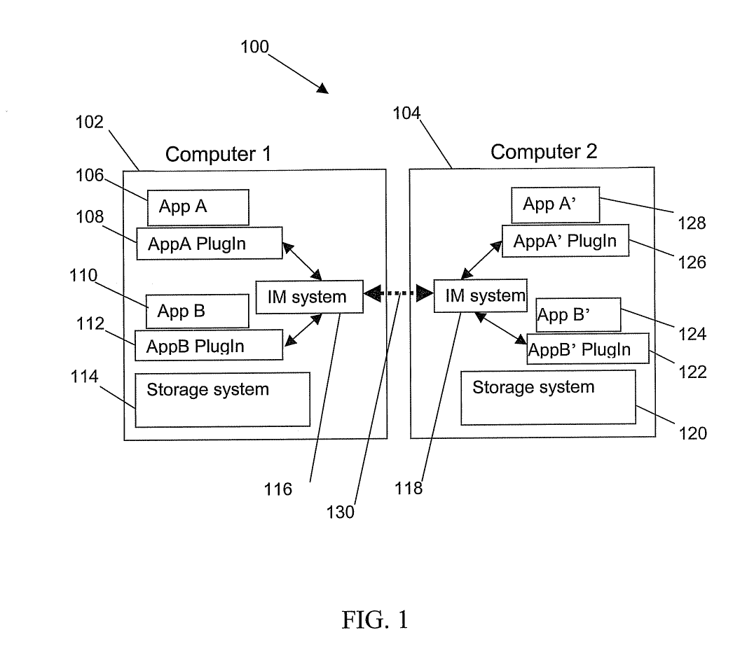

FIG. 1 is a block diagram illustrating a system 100 with interaction between two computers (102, 104) with content being shared on application software during an IM session according to embodiments of the invention. A sending user on computer 1 (102) has two applications App A (106) and App B (110) open with associated plugins (108, 112), respectively. App A and App B may be different third party applications such as a word processor, web browser, spreadsheet, presentation, planning and scheduling, drawing, financial, statistical, and gaming software.

The plugins (108, 112) are written for the applications (106, 110), and are configured to allow the applications (106, 110) to communicate with the sending IM system 116. A plug-in for an application may make a special icon available in the hosting application. When the sending user clicks and holds on this icon and then drags it to an IM window displaying a conversation with someone else, the sending user is indicating to the plug-in that they want to send a copy of the document to that user when the mouse button is released. In the event the sending user does not have an IM window open with the intended recipient, the sending user can instead release hold of the icon representing the item to be sent over an icon representing the intended recipient. The storage systems 114 and 120 may be a file system, database, and various forms of memory. A sending IM system 116 interacts with a receiving IM system 118 of computer 2 (104) to send a copy of a document or other information via an intranet, Internet, or other known networks (that are symbolized by dashed line 130). Application plugins (122, 126) open associated applications (124, 128) in the receiving computer 2 (104). The system 100 is bidirectional, wherein computer 2 (104) may also act as the sender, and computer 1 (102) acts as a receiver of an IM. The plugins (108, 112, 122, 126) send and interpret positional metadata, as well as providing hints to the receiving computer on which application to open to display an item or content.

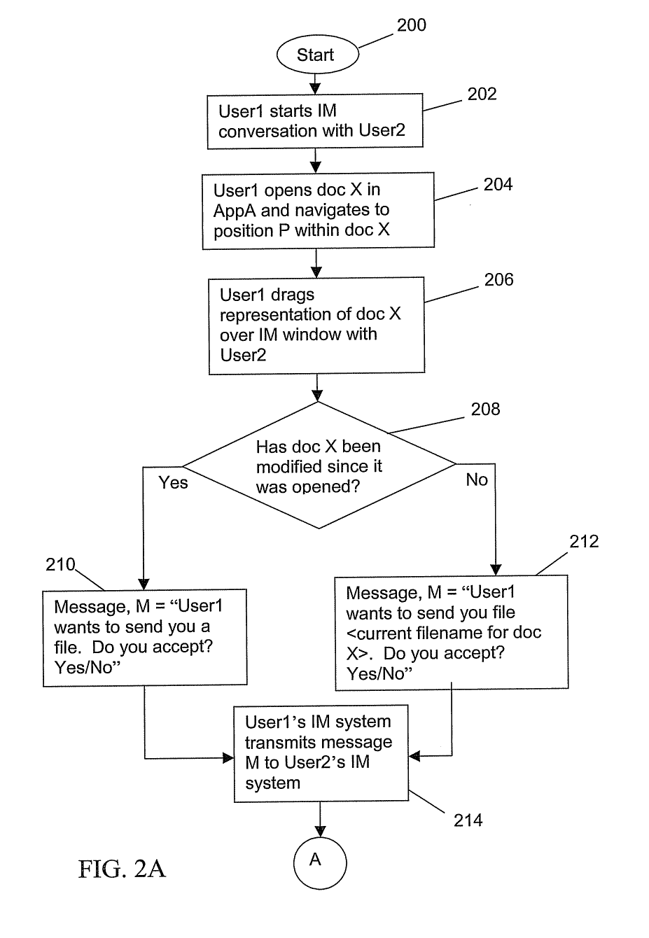

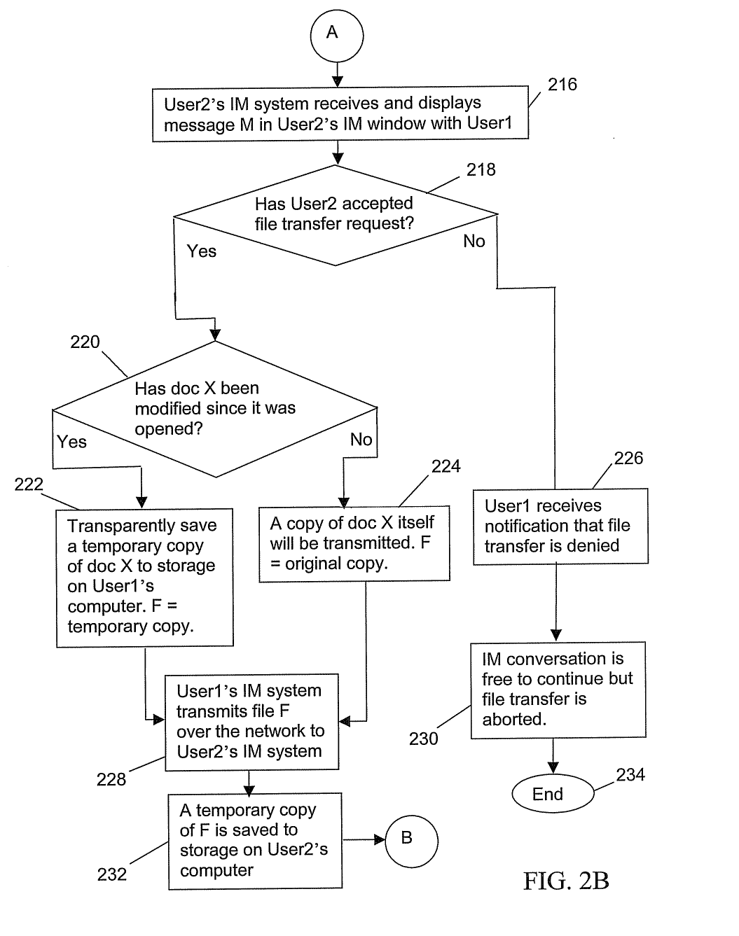

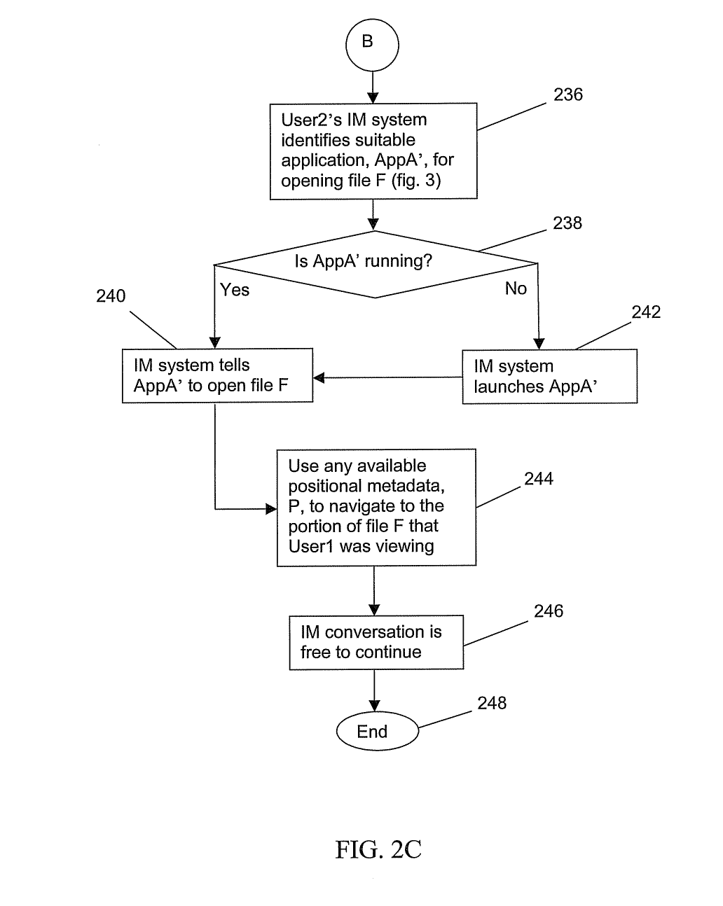

FIGS. 2A-2C illustrate a flow chart for a method for sharing information in applications via instant messaging according to embodiments of the invention. The process starts (block 200) in FIG. 2A when a User1 initiates an IM conversation with User2 (block 202). User1 opens a document X (doc X) in an application A (AppA), and navigates to a position P within doc X (block 204). It is noted that the order of blocks 202 and 204 may be reversed with no change in function. What position P constitutes is application dependent. For example, the position maybe the current page that is being viewed by the sending user (User1), even though the cursor (or currently selected cell in a spreadsheet) might be located on a different page. Next, User1 drags a representation (icon) of doc X over the IM window with User2 (block 206), with the functionality provided by associated plugins. If the doc X has been modified since it was opened (decision block 208 is Yes), a message M stating “User1 wants to send you a file. Do you accept? Yes/No” is sent to the receiving user (User2). If the doc X has not been modified (decision block 208 is No), a message M stating “User1 wants to send you a file <current filename for doc X>. Do you accept? Yes/No” is sent to the receiving user (User2) (block 212). The No pathway for decision block 208 is also the only available pathway for read-only files or files that cannot be edited (such as PDFs). Subsequently, User1's IM system transmits message M to User2's IM system (block 214).

Continuing with the flow chart in FIG. 2B, the receiving user's (User2) IM system receives and displays message M in an IM window with the sending user (User1) (block 216). If User2 does not accept the file transfer request from User1 (decision block 218 is No), User1 receives notification that the file transfer has been denied (block 226). The IM conversation is free to continue, but file transfer is aborted (block 230), and the process ends (block 234). If User2 does accept the file transfer request from User1 (decision block 218 is Yes), a determination is made if the doc X has been modified since it was opened (decision block 220). If doc X has been modified since being opened (decision block 220 is Yes), User1's system automatically and transparently saves, to storage system 114 of FIG.1, a temporary copy F of doc X on User1's computer (block 222), and the temporary copy F is transmitted over a network to User2 (block 228). If doc X has not been modified since being opened (decision block 220 is No), a copy F of doc X itself will be transmitted, where copy F is the original copy of doc X (blocks 224, 228). In both instances, metadata is transmitted along with the file F. The metadata includes positional data P, such as the page the sending user was currently viewing in a word processor, spreadsheet, etc. The metadata also includes the name and version of the application. A temporary copy of the transmitted file F is saved, to storage system 120 of FIG. 1, on the receiving user's (User2) computer (block 232).

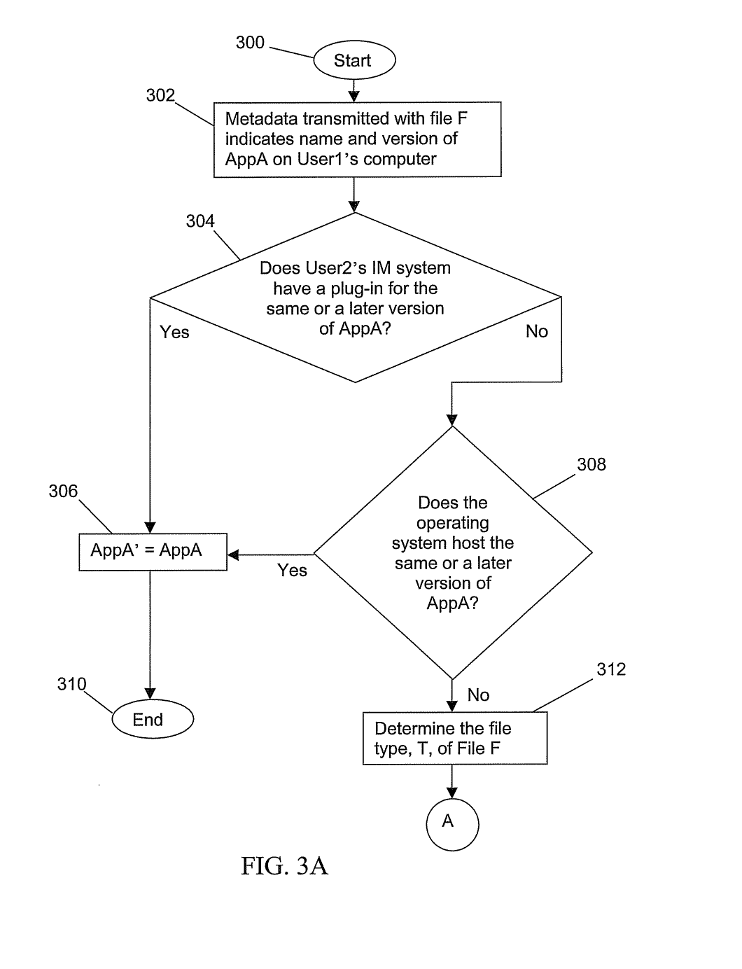

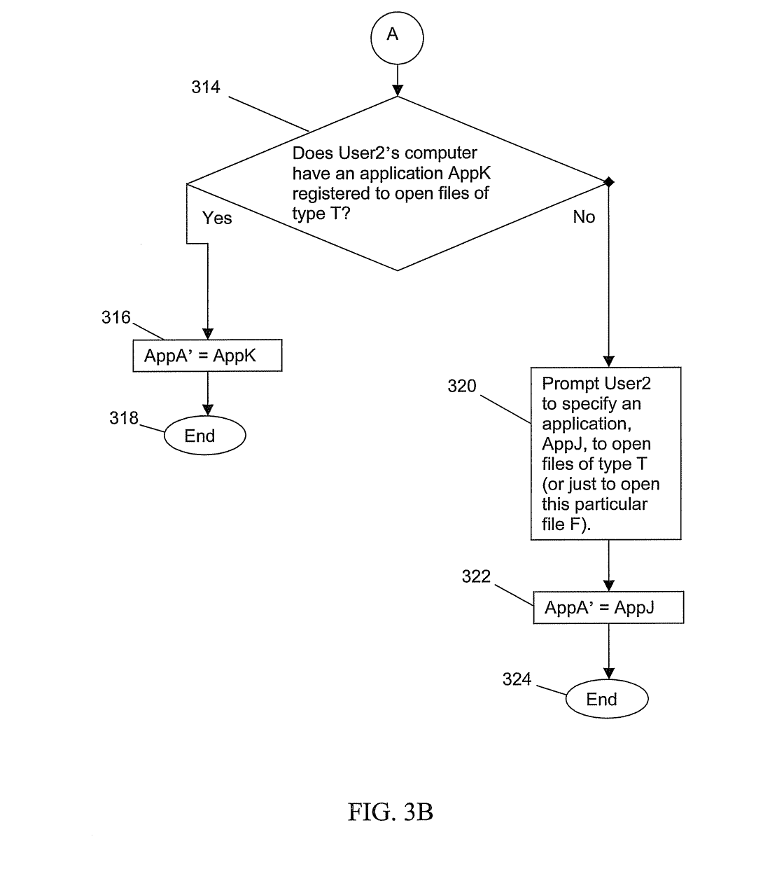

Continuing further with the flow chart in FIG. 2C, the receiving user's (User2) IM system identifies a suitable application (AppA′) for opening the file F (process explained further in FIGS. 3A and 3B) (block 236). If the identified application (AppA′) is already running (decision block 238 is Yes), User2's IM system tells the identified application to open the file F (block 240), or else (decision block 238 is No) the application (AppA′) is opened (block 242), and then the file F (block 240). User2's IM system and AppA′ utilizes any available positional metadata, P, to navigate to the portion of file F that User1 was viewing (block 244). The process steps shown in block 240 and 244, may be communicated from the IM system to AppA′ by means of the AppA′ Plugin. The implementation would depend on the features that AppA′ already provides. For example, it is conceivable that AppA′ already provides the feature that allows it to be invoked with both the name of a file to open, and also the number of the page to open the file at. If this was true for AppA′ then the communication could be done directly from the IM System to AppA without going via the plug-in. Plug-ins would still be used, however, to provide the functionality to drag representations of doc X over an IM window with User2 (see block 206). Further, the IM system would still need to know exactly how to pass the file information and positional metadata to AppA′. Following the opening of the file, the IM conversation is free to continue (block 246) until the conversation is terminated (block 248).

FIGS. 3A and 3B illustrate a flow chart for a method for a receiving computer to select an application to process and display incoming information obtained in an IM session according to embodiments of the invention. In FIG. 3A, metadata transmitted with the file F indicates name and version of application (AppA) running on User1's computer (block 302). If no metadata is available, the receiving system utilizes the file type of file F to determine which application to use. A determination is made if the receiving user's (User2) IM system has a plug-in for the same or a later version of AppA (decision block 304). If the receiving user's (User2) IM system has a plug-in for the same or a later version of AppA (decision block 304 is Yes), AppA is used to open and display the file F (block 306), and the process ends (block 310). However, if the receiving user's (User2) IM system does not have a plug-in for the same or a later version of AppA (decision block 304 is No), a determination is made as to whether the operating system hosts the same or a later version of AppA (decision block 308). If the operating system hosts the same or a later version of AppA (decision block 308 is Yes), then AppA is used to open and display file F (block 306). However, if the operating system does not host the same or a later version of AppA (decision block 308 is No), a determination of the file type T of file F is made (block 312) by examining the file extension, file header or file contents itself.

Continuing with the flow chart in FIG. 3B, a determination is made if User2's computer has an application AppK registered to open files of the determined type T (decision block 314). If User2's computer has an application AppK registered to open files of the determined type T (decision block 314 is Yes), AppK is used on User2's computer, and the process ends (block 318). However, if User2's computer does not have an application AppK registered to open files of the determined type T (decision block 314 is No), User2 is prompted to specify an application, AppJ, to open files of type T (or just to open this particular file F) (blocks 320, 322), and the process ends (block 324).

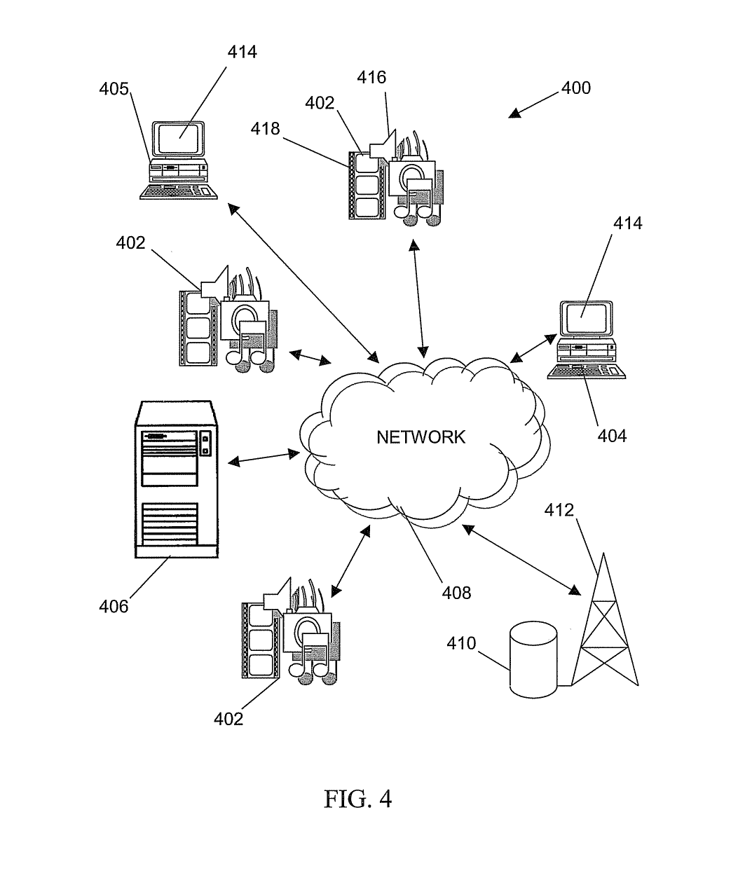

FIG. 4 is a block diagram of an exemplary system 400 for sharing information in applications via instant messaging according to embodiments of the invention, and graphically illustrates how these blocks interact in operation. The system 400 includes remote devices including one or more multimedia/communication devices 402 equipped with speakers 416 for implementing the audio, as well as display capabilities 418 for facilitating graphical user interface (GUI) aspects of the present invention. In addition, mobile computing devices 404 and desktop computing devices 405 equipped with displays 414 for use with the GUI of the present invention are also illustrated. The remote devices 402 and 404 may be wirelessly connected to a network 408. The network 408 may be any type of known network including a local area network (LAN), wide area network (WAN), global network (e.g., Internet), intranet, etc. with data/Internet capabilities as represented by server 406. Communication aspects of the network are represented by cellular base station 410 and antenna 412. Each remote device 402 and 404 may be implemented using a general-purpose computer executing a computer program for carrying out the GUI described herein. The computer program may be resident on a storage medium local to the remote devices 402 and 404, or maybe stored on the server system 406 or cellular base station 410. The server system 406 may belong to a public service. The remote devices 402 and 404, and desktop device 405 may be coupled to the server system 406 through multiple networks (e.g., intranet and Internet) so that not all remote devices 402, 404, and desktop device 405 are coupled to the server system 406 via the same network. The remote devices 402, 404, desktop device 405, and the server system 406 may be connected to the network 408 in a wireless fashion, and network 408 may be a wireless network. In a preferred embodiment, the network 408 is a LAN and each remote device 402, 404 and desktop device 405 executes a user interface application (e.g., web browser) to contact the server system 406 through the network 408. Alternatively, the remote devices 402 and 404 may be implemented using a device programmed primarily for accessing network 408 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for sharing information in applications via instant messaging (IM), wherein the method comprises:
receiving a representation of an item in a first IM window, in response to a first user on a sending device;
recording metadata associated with the item with a sending plugin;
sending the item and the associated recorded metadata, in response to a first user's command to one or more receiving devices;
wherein the item and the associated recorded metadata is received in a second IM window at the one or more receiving devices;
wherein the item is opened in response to commands from one or more receiving users with a receiving plugin;
wherein in response to the associated metadata the receiving plugin determines how to position and display information from the item;
wherein the item is one or more of the following: a uniform resource locator (URL) and files generated with application software; and
wherein the application software comprises one or more of the following: word processors, spreadsheets, planning and scheduling, presentation, drawing, financial, statistical, and gaming.

2. The method of claim 1, wherein the representation is a draggable icon or a set of tabs in a web browser.

3. The method of claim 1, wherein the metadata comprises positional data, and the name and version of the application software used to generate the files.

4. The method of claim 1, wherein the first IM window is configured with a basket feature;
wherein the basket feature receives multiple items generated by the different application software; and
wherein the multiple items in the basket are sent simultaneously to the one or more receiving devices.

5. The method of claim 1, wherein in response to a file being changed without being saved on the sending device, a temporary copy is generated and saved automatically, prior to being sent to the one or more receiving devices; and
wherein the temporary copy is configured to be sent to the one or more receiving devices.
